(19) United States
(12) Patent Application Publication
(10) Pub. No.: US 2024/0339861 A1
(43) Pub. Date: Oct. 10, 2024

(54) POWER SOURCE MONITORING DEVICE

(71) Applicant: DENSO CORPORATION, Kariya-city (JP)

(72) Inventor: Tetsuo Morita, Kariya-city (JP)

(73) Assignee: DENSO CORPORATION, Kariya-city (JP)

(21) Appl. No.: 18/744,935

(22) Filed: Jun. 17, 2024

Related U.S. Application Data
(63) Continuation of application No. PCT/JP2022/043256, filed on Nov. 23, 2022.

(30) Foreign Application Priority Data
Dec. 17, 2021 (JP) 2021-205405

(51) Int. Cl. H02J 9/06; H02J 7/00; H02J 7/34

(52) U.S. Cl. CPC H02J 9/061; H02J 7/0048; H02J 7/0063; H02J 7/34; H02J 2310/40

(57) ABSTRACT

A power source monitoring device for a power supply system equipped with a first system including a first power source and a second system including a second power source. An inter-system switch is closed under an operational state to supply power to electrical loads connected to the first and second systems. The first power source includes a voltage generation unit configured to generate an operating voltage for the electrical loads, and the second power source includes a power storage device chargeable by the voltage generation unit. The power source monitoring device includes a charging control unit configured to, under the operational state, close the inter-system switch and cause the voltage generation unit to charge the power storage device, and a dark current supply unit configured to, under a non-operational state, close the inter-system switch and supply dark current from the power storage device to the electrical loads.

### CROSS-REFERENCE TO RELATED APPLICATION

This application is a continuation application of International Application No. PCT/JP2022/043256 filed Nov. 23, 2022 which designated the U.S. and claims priority to Japanese Patent Application No. 2021-205405 filed Dec. 17, 2021, the contents of each of which are incorporated herein by reference.

### BACKGROUND

### Technical Field

This disclosure relates to a power source monitoring device.

### Related Art

In recent years, power supply systems are known that are applied to, for example, a vehicle and supply power to various devices in this vehicle. Among such power supply systems, a power supply system having a first power source and a second power source as power sources that supply power to electrical loads is known, thereby preventing a loss of functions of electrical loads that implement functions necessary for driving the vehicle, such as an electric braking device and an electric steering device, for example, even in the event that an abnormality has occurred in the electrical loads that implement these functions during driving of the vehicle.

### BRIEF DESCRIPTION OF THE DRAWINGS

In the accompanying drawings:

FIG. 1 is an overall configuration diagram of a power supply system according to a first embodiment;

FIG. 2 is a flowchart illustrating steps of a control process;

FIG. 3 is a timing diagram illustrating a progress of a SOC of a rechargeable battery according to the first embodiment;

FIG. 4 is a timing diagram illustrating a progress of a SOC of a rechargeable battery according to a second embodiment;

FIG. 5 is an overall configuration diagram of a power supply system according to another embodiment; and

FIG. 6 is an overall configuration diagram of a power supply system according to another embodiment.

### DESCRIPTION OF SPECIFIC EMBODIMENTS

The above known power supply system, as disclosed in JP 2019-62727 A, includes a first system with the first power source and a second system with the second power source. In this known power supply system, an inter-system switch is provided along a connection path connecting the two systems, such that when an abnormality occurs in one of the power supply systems and thus a current exceeding a current threshold flows through the connection path, the inter-system switch is opened by a control device. This allows loads in the other of the two systems, in which no abnormality has occurred, to implement the functions necessary for driving the vehicle.

The above power supply system may be configured such that a rechargeable battery is provided as the second power source and the rechargeable battery is charged by power supplied from the first power source. In such a configuration, the rechargeable battery is charged to provide a power supply backup for the electrical loads while the power supply system is in operation. However, assuming continued use under normal operating conditions with no abnormalities in any of the power supply systems, charging and spontaneous discharging of the rechargeable battery in the second system are merely repeated. Therefore, there is room for improvement in terms of the power efficiency and the like.

In view of the foregoing, it is desired to have a power source monitoring device for a power supply system with redundant power sources, capable of efficient use of power of each redundant power source.

One aspect of the present disclosure provides a power source monitoring device for a power supply system equipped with a first system including a first power source and a second system including a second power source. The first and second systems are connectable to each other by an inter-system switch. The inter-system switch is configured to be closed under an operational state of the power supply system to supply power to electrical loads connected to a respective one of the first and second systems. The first power source includes a voltage generation unit configured to generate an operating voltage for the electrical loads, and the second power source includes a power storage device chargeable by the voltage generation unit. The power source monitoring device includes a charging control unit configured to, under the operational state of the power supply system, close the inter-system switch and cause the voltage generation unit to charge the power storage device, and a dark current supply unit configured to, under a non-operational state of the power supply system, close the inter-system switch and supply dark current from the power storage device to the electrical loads.

According to the above configuration, the power supply system includes the first power source equipped with the voltage generation unit and the second power source equipped with the power storage device, which allows the electrical loads to be supplied redundantly with power from each of these power sources.

In this case, under the operative state of the power supply system, the power storage device is charged by the voltage generation unit with the inter-system switch closed, so that even in the event that a power source failure occurs on the first system side, driving of the loads can be continued by the power storage device on the second system side. Under the non-operative state of the power supply system, dark current is supplied from the power storage device to the electrical loads with the inter-system switch closed. In this case, the power storage device is in a charged state in preparation for a power source failure on the first system side, and dark current is supplied to the electrical loads while making effective use of the power in the power storage device. This can properly implement redundant power supplies and efficient use of power of each power source in the power supply system.

In the power source monitoring device configured as above, the charging control unit may include a first charging unit configured to cause the power storage device to be charged so that, under the operational state of the power supply system, a remaining capacity of the power storage device is higher than or equal to a lower limit capacity which is a capacity to allowed provide a power supply backup for the electrical loads, and a second charging unit configured to cause the power storage device to be charged under a non-operational state of the power supply system when the remaining capacity of the power storage device is lower than the lower limit capacity and falls to a capacity threshold which is a capacity allowed to supply dark current to the electrical loads.

In the above configuration, the capacity threshold at which charging is performed under the non-operational state of the power supply system is set to a smaller value than the lower limit capacity, which is the capacity that can provide a power supply backup for the loads under the operational state of the power supply system. Here, the capacity that can provide a power supply backup refers to the power capacity that allows driving of electrical loads connected to the second system to be continued even in the event that a power source failure on the first system side has occurred under the operative state of the power supply system. In this case, the capacity range of the power storage device that can be used to supply dark current under the non-operational state of the power supply system is broadened, and dark current is supplied even when the remaining capacity of the power storage device is lower than the lower limit capacity in the operational state of the power supply system. This can reduce the number of times the power storage device is charged under the non-operational state of the power supply system.

In the power source monitoring device configured as above, the power supply system may be an on-board power supply system for a vehicle. The electrical loads may be loads for implementing driving assistance functions in the vehicle. The first charging unit may be configured to cause the power storage device to be charged under the operational state of the power supply system so that the remaining capacity of the power storage device is higher than or equal to a lower limit capacity that is a capacity allowed to provide a power supply backup while driving assistance is being performed. The second charging unit may be configured to cause the power storage device to be charged under the non-operational state of the power supply system so that the remaining capacity of the storage device has dropped to a capacity threshold that is a capacity lower than the lower limit capacity.

According to the above configuration, in the power supply system applied to a vehicle equipped with electrical loads for implementing driving assistance functions, the capacity threshold at which the second charging unit initiates charging under the non-operational state of the power supply system is set to a smaller value than the lower limit capacity, which is the capacity that can provide a power supply backup while driving assistance is being performed. This can reduce the number of times the power storage device is charged under the non-operational state of the power supply system while ensuring that a power supply backup is properly provided while driving assistance is being performed.

The power source monitoring device configured as above may include a prediction unit configured to predict a start timing when the driving assistance is started after transitioning from the non-operational state to the operational state of the power supply system, where the second charging unit is configured to set the capacity threshold based on the start timing.

When the remaining capacity of the power storage device falls below the lower limit capacity SC under the non-operational state of the power supply system, the remaining capacity of the power storage device may be lower than the lower limit capacity SC at the time of system activation, and driving of the vehicle in the assistance mode may thus be delayed until the remaining capacity of the power storage device is charged to the lower limit capacity SC or higher. In this regard, in the above configuration, the start timing when the driving mode of the vehicle is switched to the assistance mode after transitioning from the non-operational state to the operational state of the power supply system is predicted, and the capacity threshold is set based on that start timing. For example, the capacity threshold may be set higher as the time period from when the power supply system is activated to the start timing is shorter. This allows driving of the vehicle in the assistance mode to be started at the desired timing after the power supply system is activated.

In the power source monitoring device configured as above, the second charging unit may be configured to set the capacity threshold based on a rate of change of the remaining capacity of the power storage device associated with discharging of the power storage device under the non-operational state of the power supply system.

For example, when discharge from the power storage device is performed to an electrical load in use under the non-operative state of the power supply system, the rate of change of the remaining capacity of the power storage device under the non-operative state of the power supply system increases due to the supply of drive current as well as dark current to the electrical load, and there is concern that the number of times the power storage device is charged under the non-operational state of the power supply system may increase. In this regard, in the above configuration, the capacity threshold may be set based on the rate of change of the remaining capacity of the power storage device associated with discharging of the power storage device under the non-operational state of the power supply system. For example, if the rate of change of the remaining capacity of the power storage device under the non-operational state of the power supply system is relatively large, the capacity threshold may be set lower. This can advantageously reduce the number of times the power storage device is charged under the non-operational state of the power supply system.

In the power source monitoring device configured as above, the first charging unit may be configured to cause the power storage device to be charged under the operational state of the power supply system with an upper limit of the remaining capacity of the power storage device set as a first upper limit. The second charging unit may be configured to cause the power storage device to be charged under the non-operational state of the power supply system with the upper limit of the remaining capacity of the power storage device set as a second upper limit, which is lower than the first upper limit.

Under the operational state of the power supply system, the power supply backup for the loads may be properly provided by keeping the remaining capacity of the power storage device at a high capacity. However, there is concern that if the time period during which the remaining capacity of the power storage device is kept at a high capacity is prolonged, the power storage device may likely deteriorate. In this regard, in the above configuration, the second upper limit, which is the upper limit of power storage device under the non-operational state of the power supply system, is set to a smaller value than the first upper limit, which is the upper limit of power storage device under the operational state of the power supply system. In this case, the remaining capacity of the power storage device is kept at a high capacity under the operational state of the power supply system, and the remaining capacity of the power storage device is kept at a low capacity under the non-operational state of the power supply system. This can suppress deterioration of the power storage device while ensuring a power supply backup is provided properly under the operational state of the power supply system.

In the power source monitoring device configured as above, the power supply system may be an on-board power supply system for a vehicle. The electrical loads may be loads for implementing driving assistance functions in the vehicle. The charging control unit may include a first charging unit configured to cause the power storage device to be charged so that, under the operational state of the power supply system, a remaining capacity of the power storage device is higher than or equal to a lower limit capacity which is a capacity allowed to provide a power supply backup for the electrical loads while the vehicle is driven in a driving assistance mode, and a second charging unit configured to cause the power storage device to be charged under a non-operational state of the power supply system when the remaining capacity of the power storage device falls to the lower limit capacity.

According to the above configuration, under the non-operational state of the power supply system, the power storage device is charged when the remaining capacity of the power storage device drops to the lower limit capacity, which is the capacity that can provide a power supply backup while the vehicle is traveling in the assistance mode. In this case, since the remaining capacity of the power storage device is kept at a higher capacity than the lower limit capacity under the non-operational state of the power supply system, a power supply backup for driving assistance can be provided by the power storage device even immediately after the power supply system is activated. This allows driving of the vehicle in the assistance mode to be started as soon as possible immediately after system activation.

In the power source monitoring device configured as above, the electrical loads may include a load that does not need to be supplied with dark current under the non-operational state of the power supply system and a load that needs to be supplied with dark current under the non-operational state of the power supply system. The first and second systems may include an intra-system switch provided in an energization path leading to the load that does not need to be supplied with dark current under the non-operational state of the power supply system. The dark current supply unit may be configured to, under the non-operational state of the power supply system, open the intra-system switch and close the inter-system switch to cause the power storage device to supply dark current to the load that needs to be supplied with dark current under the non-operational state of the power supply system.

In the above configuration, during dark current being supplied from the power storage device to the electrical loads under the non-operational state of the power supply system, the intra-system switch is opened, thereby preventing dark current from being supplied to the load that does not need to be supplied with dark current. This can suppress the amount of dark current supplied from the power storage device under the non-operational state of the power supply system, and reduce the number of times the power storage device is charged under the non-operational state of the power supply system.

### First Embodiment

An embodiment in which a power source monitoring device according to the present disclosure is applied to a power supply system 100 mounted to a vehicle will now be described with reference to the accompanying drawings.

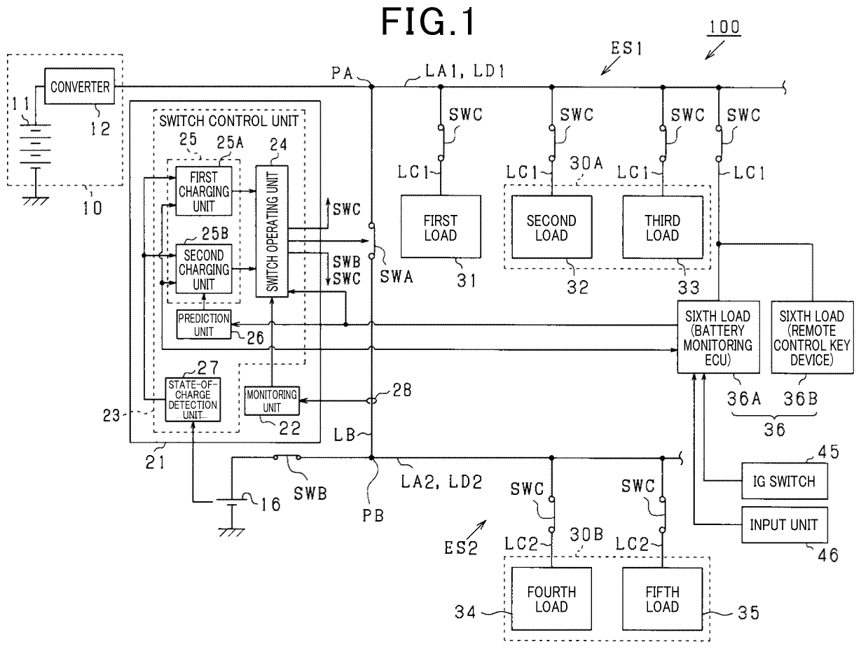

As illustrated in FIG. 1, the power supply system 100 includes two power systems. In the first system, ES1, which is one of the power systems, a power supply device 10 is provided as the first power source unit. In the second power system, ES2, which is the other of the power systems a rechargeable battery 16 is provided as the second power source unit.

The power supply device 10 and the rechargeable battery 16 are power sources that supply power to the first to sixth loads 31-36. The power supply device 10 includes a high-voltage rechargeable battery 11 and a DC-DC converter (in the following, simply referred to as a converter) 12. The high-voltage rechargeable battery 11 is a rechargeable battery capable of outputting a higher voltage (e.g., several hundred volts) than the rated voltage of the rechargeable battery 16 (e.g., 12 V), for example, a rechargeable lithium-ion battery. The converter 12 is a voltage generation unit that steps down the power supplied from the high-voltage rechargeable battery 11 to generate an operating voltage for the first to sixth loads 31-36. The high-voltage rechargeable battery 11 may be installed external to the power supply system 100. The rechargeable battery 16 is a power storage device including, for example, a rechargeable lithium-ion battery.

Of the first to sixth loads 31-36, the first to fifth loads 31-35 are loads that do not need to be supplied with dark current under a non-operational state of the power supply system 100, and the sixth load 36 is a load that needs to be supplied with dark current during the non-operational state of the power supply system. The sixth load 36 includes a battery monitoring electronic control unit (ECU) (hereinafter simply referred to as an ECU) 36A that monitors the rechargeable battery 16, a remote-control key device 36B, and the like. In the present embodiment, the first to fifth loads 31-35 correspond to loads that do not need to be supplied with dark current, and the sixth load 36 corresponds to a load that needs to be supplied with dark current.

Of the first to fifth loads 31-35, the first load 31 is an electrical load that is not used for driving the vehicle, such as an air conditioner, an audio device, power windows.

On the other hand, the second to fifth loads 32-35 are loads that implement at least one function used to drive the vehicle, such as an electric power steering device to steer the vehicle, an electric braking device to apply braking force to the wheels, and a driving monitoring device to monitor surroundings of the vehicle.

The second to fifth loads 32 to 35 are configured as being provided with redundancy for each function. Specifically, the second load 32 and the third load 33 form a first load group 30A, and the fourth load 34 and the fifth load 35 form a second load group 30B, such that even in the event of an abnormality occurring in either of these load groups 30A and 30B, not the entirety of each function is not lost. The first load group 30A and the second load group 30B are redundantly provided for each function. Although the first load group 30A and the second load group 30B corporate together to implement each function, each of the first load group 30A and the second load group 30B is also capable of implementing part of each function independently.

For example, the second to fifth loads 32-35 include, as the electric power steering system, a first steering motor and a second steering motor, as well as a first control device that controls the first steering motor and a second control device that controls the second steering motor.

In this case, the first load group 30A, which includes the first control device corresponding to the second load 32 and the first steering motor corresponding to the third load 33, and the second load group 30B, which includes the second control device corresponding to the fourth load 34 and the second steering motor corresponding to the fifth load 35, corporate together to achieve steering of the vehicle. Nonetheless, each of the first load group 30A and the second load group 30B may be alone capable of freely steering the vehicle. Specifically, the first load group 30A and the second load group 30B can steer the vehicle with certain limitations on the steering speed and the steering angle.

Of the second to fifth loads 32-35, the third and fifth loads 33 and 35 are loads that can tolerate instantaneous power supply interruption, e.g., various actuators. The second and fourth loads 32 and 34 are loads that cannot tolerate instantaneous power supply interruption, e.g., control devices for various actuators.

The second load 32 and the fourth load 34 can cooperatively implement driving assistance functions such as the Lane Keeping Assist (LKA), the Adaptive Cruise Control (ACC), the Pre-Crash Safety (PCS), and the like. The second load 32 and the fourth load 34 allow the driving mode of the vehicle to switch between an assistance mode that uses driving assistance control and a normal mode that does not use driving assistance control, and the vehicle can be driven in each of the driving modes.

In the first system ES1, the power supply device 10 is connected to the first to third and sixth loads 31-33, 36 via the first intra-system path LA1. In the present embodiment, the power supply device 10 and the first to third and sixth loads 31-33, 36 connected by the first intra-system path LA1 constitute the first system ES1. In the present embodiment, no power storage devices such as rechargeable batteries are connected to the low voltage side of the converter 12 within the first system ES1.

In the second system ES2, the rechargeable battery 16 is connected to the fourth and fifth loads 34, 35 via the second intra-system path LA2. In the present embodiment, the rechargeable battery 16 and the fourth and fifth loads 34, 35 connected by the second intra-system path LA2 constitute the second system ES2.

The intra-system paths LA1 and LA2 are connected to each other by a connection path LB, and an inter-system switch SWA is provided in the connection path LB. One end of the connection path LB is connected to a connection point PA of the first intra-system path LA1, and the other end of the connection path LB is connected to a connection point PB of the second intra-system path LA2. In the second intra-system path LA2, a power source switch SWB is provided between the connection point PB and the rechargeable battery 16. In the present embodiment, an N-channel MOSFET (simply MOSFET in the following) is used as each of the inter-system switch SWA and the power source switch SWB.

The first intra-system path LA1 has the first to third and sixth loads 31-33, 36 connected in parallel with each other, and intra-system switches SWC are provided in first branching paths LC1 leading to the respective electrical loads. The intra-system switches SWC may be, for example, MOSFETs. The first branching paths LC1 are connected to a first main path LD1 from which the first branching paths LC1 are branched, and is connected to the power supply device 10 via the first main path LD1. In the present embodiment, each first branching path LC1 corresponds to an “energization path.”

The second intra-system path LA2 has the fourth and fifth loads 34, 35 connected in parallel with each other, and intra-system switches SWC are provided in second branching paths LC2 leading to the respective electrical loads. The second branching paths LC2 are connected to a second main path LD2 from which the second branching paths LC2 are branching, and are connected to the rechargeable battery 16 via the second main path LD2.

The connection path LB is provided with a voltage sensor 28 that detects a voltage at the connection point PA.

The ECU 36A is configured as a well-known microcomputer including a CPU, a ROM, a RAM, a flash memory, and the like. The CPU implements various functions for manual and autonomous driving with reference to computing programs and control data stored in the ROM. Specifically, the ECU 36A switches the high-voltage rechargeable battery 11 and the converter 12 between an operational state and a non-operational state.

Manual driving represents a state in which driving of the vehicle is controlled by driver's driving operations. Autonomous driving represents a state in which driving of the vehicle is controlled according to controls by the control device 40, without any driving operations by the driver. Specifically, autonomous driving is defined as autonomous driving at Level 3 or higher of the autonomous driving levels 0 to 5 as defined by the National Highway Traffic Safety Administration (NHTSA) of the U.S. Department of Transportation. In manual driving, the vehicle is capable of driving in a normal mode. In autonomous driving, the vehicle is capable of driving in an assistance mode.

The ECU 36A is connected to an IG switch 45 and an input unit 46. The IG switch 45 is a vehicle activation switch. The ECU 36A monitors the on/off state of the IG switch 45. The input unit 46 is a device that receives driver's operations, and may be, for example, a steering wheel operation input device, a shift lever operation input device, an accelerator pedal operation input device, a brake pedal operation input device, and a voice input device.

The power supply system 100 includes a switch control device 21 as the power source monitoring device. The switch control device 21 includes a monitoring unit 22 and a switch control unit 23. The monitoring unit 22 is connected to the voltage sensor 28 and determines whether a power source failure has occurred in the first system ES1 based on detected voltage values by the voltage sensor 28.

The switch control unit 23 is connected to the monitoring unit 22 and each of the switches SWA to SWC, and is operative to switch each of the switches SWA to SWC between open and closed states based on a result of determination by the monitoring unit 22. For example, when the monitoring unit 22 determines that a power source failure has occurred in the first ES1 system, the switch control unit 23 opens the inter-system switch SWA to electrically isolate the first system ES1 from the second system ES2 and closes the power source switch SWB to supply power from the rechargeable battery 16 to the loads 34, 35 in the second system ES2.

Under the operational state of the power supply system 100 in which the IG switch 45 is on, the inter-system switch SWA and the intra-system switches SWC are closed by the switch control unit 23, and power is supplied to the loads 31 to 36 connected to the respective systems ES1 and ES2. In addition, the power source switch SWB is closed by the switch control unit 23, and the rechargeable battery 16 is charged by the power supply device 10. Even if a power source failure occurs in the first system ES1 and the inter-system switch SWA is thus opened by the switch control unit 23, this allows driving of the loads 34 and 35 in the second system ES2 to be continued by power from the rechargeable battery 16, that is, this can provide a power supply backup for the loads 34 and 35 in the second system ES2.

However, under normal operating conditions where no power source failure has occurred in any of the power systems, the power source switch SWBis opened by the switch control unit 23 and the rechargeable battery 16 is discharged spontaneously, after the rechargeable battery 16 is charged. Thus, since charging and spontaneous discharging of the rechargeable battery are merely repeated under normal operating conditions, power stored in the rechargeable battery 16 may not be used effectively, and there is therefore room for improvement in terms of power efficiency and the like.

In the present embodiment, under the non-operational state of the power supply system 100 in which the IG switch 45 is off and voltage generation by the converter 12 is at a standstill, dark current is supplied from the rechargeable battery 16 to the sixth load 36 with the inter-system switch SWA and the power source switch SWB being closed by the switch control unit 23.

The operations of the switch control unit 23 when the rechargeable battery 16 is charged and discharged will now be described. The switch control unit 23 is hardened circuitry that includes a switch operating unit 24, a charging control unit 25, a prediction unit 26, and a state-of-charge detection unit 27.

The switch operating unit 24 closes the inter-system switch SWA and the power source switch SWB under the non-operational state of the power supply system. This allows dark current to be suppled from the rechargeable battery 16 to the sixth load 36. When the power supply system 100 transitions from the operational state to the non-operational state, all the intra-system switches SWC in the power supply system 100 are closed. If dark current is supplied from the rechargeable battery 16 in this state, dark current is supplied not only to the sixth load 36, which needs to be supplied with dark current under the non-operational state of the power supply system, but also to the first to fifth loads 31 to 35, which do not need to be supplied with dark current, resulting in unnecessary consumption of power in the rechargeable battery 16. Therefore, when the switch operating unit 24 detects that the power supply system 100 has transitioned to the non-operational state, the switch operating unit 24 opens the intra-system switches SWC in the system other than the intra-system switch SWC corresponding to the sixth load 36. In the present embodiment, the switch operating unit 24 corresponds to a “dark current supplying unit.”

The state-of-charge detection unit 27 detects the state of charge (SOC) of the rechargeable battery 16, which indicates the remaining capacity of the rechargeable battery 16. The charging control unit 25 outputs a charging signal to the switch operating unit 24 when the SOC of the rechargeable battery 16 detected by the state-of-charge detection unit 27 drops to a predefined capacity. When the charging signal is output from the charging control unit 25, the switch operating unit 24 closes the inter-system switch SWA and the power source switch SWB. This allows the rechargeable battery 16 to be charged by the power supply device 10.

The charging control unit 25 includes a first charging unit 25A and a second charging unit 25B. Under the operational state of the power supply system, the first charging unit 25A outputs a charging signal to the switch operating unit 24 so that the SOC of the rechargeable battery 16 is higher than or equal to a predefined lower limit capacity SC. Here, the lower limit capacity SC is a capacity in the rechargeable battery 16 that can provide a power supply backup for the first to sixth loads 31 to 36. In detail, the lower limit capacity SC is a capacity in the rechargeable battery 16 that can provide a power supply backup for the loads 34 and 35 in the second system ES2 during driving of the vehicle in the assistance mode, that is, while driving assistance is being performed.

Here, the capacity that can provide a power supply backup refers to the power capacity that allows the loads 34 and 35 in the second system ES2 to continue to be driven until the vehicle is brought to safe conditions, even if an abnormality occurs in the first system ES1 and its functions are lost during driving of the vehicle. For example, it is the power capacity required to bring the running vehicle safely to a standstill within the lane in which the vehicle is traveling, i.e., to bring the vehicle to a standstill by applying brakes while keeping the lane. For example, it is the power capacity required to bring the running vehicle safely to a standstill on the shoulder of the road, i.e., to make a lane change to move to the shoulder of the road while checking for other vehicles traveling alongside, and then to apply the brakes to bring the vehicle to a standstill. For example, it is the power capacity required to bring the running vehicle to a standstill in a waiting or parking area, that is, an area for the vehicle to be parked.

Under the operational state of the power supply system, the first charging unit 25A outputs the charging signal to the switch operating unit 24 when the SOC of the rechargeable battery 16 drops to the lower limit capacity SC. The first charging unit 25A outputs the charging signal until the SOC of the rechargeable battery 16 increases to a predefined first upper limit SA, and ceases outputting the charging signal when the SOC of the rechargeable battery 16 reaches the first upper limit SA. Upon the first charging unit 25A ceasing outputting the charging signal, the switch operating unit 24 keeps the inter-system switch SWA in the closed state and opens the power source switch SWB.

Under the non-operational state of the power supply system, the second charging unit 25B outputs the charging signal to the switch operating unit 24 when the SOC of the storage battery 16 drops to a predefined capacity threshold SD. Here, the capacity threshold SD is a capacity that is lower than the lower limit capacity SC and allows dark current to be supplied to the sixth load 36.

Under the non-operational state of the power supply system, the second charging unit 25B outputs an activation signal to the ECU 36A to activate the high-voltage rechargeable battery 11 and the converter 12 when the SOC of the rechargeable battery 16 drops to the capacity threshold SD. This allows the high-voltage rechargeable battery 11 and the converter 12 to be activated, and the rechargeable battery 16 to be charged by the converter 12. The operating voltage of the converter 12 allows dark current to be supplied to the sixth load 36. The second charging unit 25B outputs the charging signal until the SOC of the rechargeable battery 16 increases and reaches a predefined second upper limit SB. Here, the second upper limit SB is a capacity lower than the first upper limit SA and higher than the lower limit capacity SC.

When the SOC of the rechargeable battery 16 increases to the second upper limit SB, the second charging unit 25B ceases outputting the charging signal and outputs a deactivation signal to the ECU 36A to deactivate the high-voltage rechargeable battery 11 and converter 12. Upon the high-voltage rechargeable battery 11 and converter 12 being deactivated, charging of the rechargeable battery 16 is ceased and dark current is supplied from the rechargeable battery 16 to the sixth load 36. Under the non-operational state of the power supply system, the switch operating unit 24 keeps the inter-system switch SWA and the power source switch SWB in the closed state even when the first charging unit 25A ceases outputting the charging signal.

In the present embodiment, the capacity threshold SD is set to a capacity lower than the lower limit capacity SC. However, with the capacity threshold SD set to a capacity less than the lower limit capacity SC, when the SOC of the rechargeable battery 16 is lower than the lower limit capacity SC at the time of system activation, driving of the vehicle in the assistance mode may be delayed until the SOC of the rechargeable battery 16 is charged to the lower limit capacity SC or higher. Therefore, the prediction unit 26 predicts the start timing at which driving assistance is started after transitioning from the non-operational state to the operational state of the power supply system. The prediction unit 26 acquires past vehicle driving patterns from the ECU 36A and predicts the start timing based on these vehicle driving patterns. The vehicle driving patterns include, for example, the frequency of use of driving assistance functions, the frequency of use of the car navigation device, and the set time period when the car navigation device is used. The second charging unit 25B sets the capacity threshold SD based on the start timing predicted by the prediction unit 26. Specifically, the second charging unit 25B sets a higher capacity threshold SD as the time period from when the IG switch 45 is switched on to the start timing is shorter.

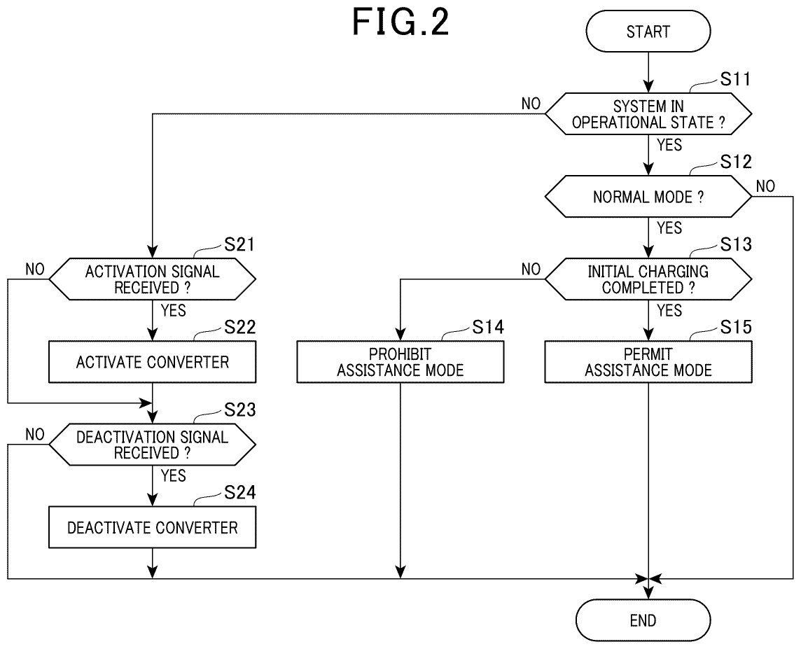

Next, the operations of the ECU 36A when the rechargeable battery 16 is charged and discharged will now be described. FIG. 2 illustrates a flowchart of the process performed by the ECU 36A under the operational and control non-operational states of the power supply system.

Upon initiation of the control process, first, at step S11, the ECU 36A determines whether the power supply system 100 is in the operational state. The ECU 36A determines whether the power supply system 100 is in the operational state based on the on/off state of the IG switch 45, for example. If it is determined that the power supply system 100 is in the operational state, the process flow proceeds to step S12. If it is determined that the power supply system 100 is in the non-operational state, the process flow proceeds to step S21.

At step S12, the ECU 36A determines whether the driving mode of the vehicle is a normal mode. If it is determined that the driving mode of the vehicle is the normal mode, the process flow proceeds to step S13. If it is determined that the driving mode of the vehicle is an assistance mode, then this process ends.

At step S13, the ECU 36A determines whether the initial charging of the rechargeable battery 16 has been completed. Specifically, the ECU 36A determines whether the SOC of rechargeable battery 16 is higher than the lower limit capacity SC. The ECU 36A determines whether the SOC of the rechargeable battery 16 is higher than the lower limit capacity SC based on signals from the first charging unit 25A. If it is determined that the SOC of the rechargeable battery 16 is lower than the lower limit capacity SC, then at step S14 the ECU 36A prohibits switching to the assistance mode and this process ends. If it is determined that the SOC of the rechargeable battery 16 is higher than the lower limit capacity SC, then at step S15 the ECU 36A permits switching to the assistance mode and this process ends. The switching to the assistance mode is performed based on an instruction from the driver via the input unit.

At step S21, the ECU 36A determines whether the activation signal has been received from the second charging unit 25B. If it is determined that the activation signal has been received, then at step S22 the ECU 36A activates the high-voltage rechargeable battery 11 and the converter 12, and the process flow proceeds to step S23. If it is determined that the activation signal has not been received, the process flow proceeds to step S23.

At step S23, the ECU 36A determines whether the deactivation signal has been received from the second charging unit 25B. If it is determined that the deactivation signal has been received, then at step S24 the ECU 36A deactivates the high-voltage rechargeable battery 11 and the converter 12 and this process ends. If it is determined that the deactivation signal has not been received, this process ends.

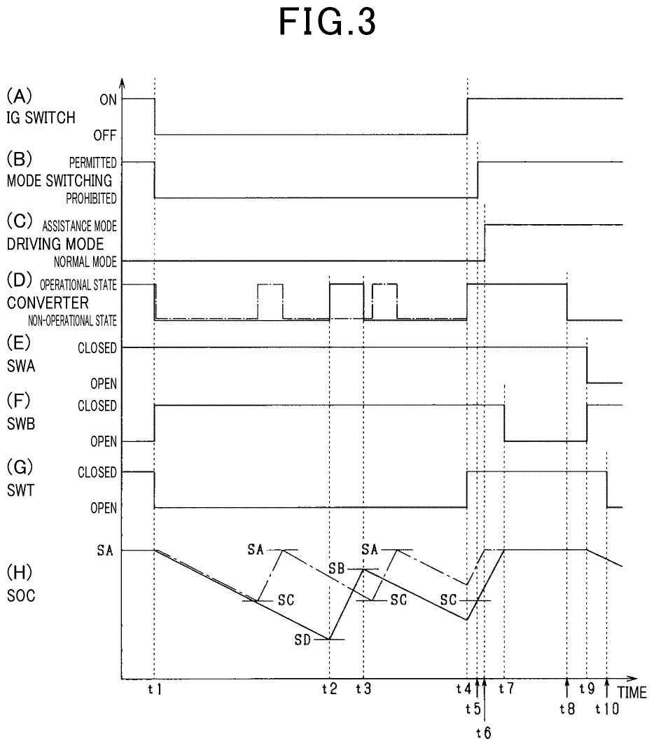

FIG. 3 illustrates the progress of the SOC of the rechargeable battery 16 under the operational and non-operational states of the power supply system. In FIG. 3, the diagram (A) illustrates the progress of the on/off state of the IG switch 45, the diagram (B) illustrates the progress of permission or prohibition of switching to the assistance mode, the diagram (C) illustrates the progress of the driving assistance mode, and the diagram (D) illustrates the progress of the operating state of converter 12. The diagram (E) illustrates the progress of the open/closed state of the inter-system switch SWA, the diagram (F) illustrates the progress of the open/closed state of the power source switch SWB, the diagram (G) illustrates the progress of the open/closed state of a specific switch SWT that is the intra-switch SWC corresponding to the first load 31, and the diagram (H) illustrates the progress of the SOC of the rechargeable battery 16.

As illustrated in FIG. 3, during the time period where the IG switch 45 is closed until time t1, i.e., under the operational state of the power supply system 100, the power source switch SWB is open and the SOC of the rechargeable battery 16 is kept at the first upper limit SA.

When the IG switch 45 is opened at time t1, the converter 12 is deactivated and the power source switch SWB is closed by the switch operating unit 24. This allows dark current to be supplied from the rechargeable battery 16 to the sixth load 36. In the present embodiment, since the specific switch SWT is opened by the switch operating unit 24 at time t1, dark current is prevented from being supplied to the first load 31 that does not need to be supplied with dark current under the non-operational state of the power supply system.

Under the non-operational state of the power supply system from time t1 to time t4, dark current is supplied from the rechargeable battery 16 to the sixth load 36, and the rechargeable battery 16 is charged by the converter 12. Specifically, during the time period from time t1 to time t2, dark current is supplied from the storage battery 16 by the switch operating unit 24, and when the SOC of the storage battery 16 drops to the capacity threshold SD at time t2, the rechargeable battery 16 is charged by the second charging unit 25B. Then, when the SOC of the rechargeable battery 16 increases to the second upper limit SB at time t3, charging of the rechargeable battery 16 is ceased by the second charging unit 25B, and dark current is supplied from the rechargeable battery 16 again.

In the present embodiment, the capacity threshold SD at which the second charging unit 25B initiates charging of the rechargeable battery 16 under the non-operational state of the power supply system is set to a smaller value than the lower limit capacity SC that is the capacity at which the power supply backup for the loads 34, 35 of the second system ES2 can be provided under the operational state of the power supply system. Therefore, under the non-operational state of the power supply system, the capacity range of the rechargeable battery 16 that can be used to supply dark current is broadened, and dark current is supplied even when the SOC of the rechargeable battery 16 is lower than the lower limit capacity SC.

The second upper limit SB at which the second charging unit 25B ceases charging of the rechargeable battery 16 under the non-operational state of the power supply system is set to a smaller value than the first upper limit SA at which the first charging unit 25A ceases charging of the rechargeable battery 16 under the operational state of the power supply system. Therefore, under the non-operational state of the power supply system, the SOC of the rechargeable battery 16 is kept at a lower capacity than the second upper limit SB, and it is prevented from becoming as high as the first upper limit SA.

In the present embodiment, the capacity range from the second upper limit SB to the capacity threshold SD, that is, the capacity range in which the second charging unit 25B charges the rechargeable battery 16 under the non-operational state of the power supply system, is broader than the capacity range from the first upper limit SA to the lower limit capacity SC, that is, the capacity range in which the first charging unit 25A charges the rechargeable battery 16 under the operational state of the power supply system. As indicated by dashed-dotted lines in FIGS. 3(D) and 3(H), this allows the number of times the power storage device is charged under the non-operational state to be reduced as compared to the case where the capacity range in which the rechargeable battery 16 is charged under the operational state of the power supply system is set to the capacity range from the first upper limit SA to the lower limit capacity SC.

When the IG switch 45 is closed at time t4, the converter 12 is activated and the specific switch SWT is closed by the switch operating unit 24. In addition, the inter-system switch SWA and the power source switch SWB are kept closed by the first charging unit 25A. As a result, the rechargeable battery 16 is charged by the power supply device 10. When the SOC of the rechargeable battery 16 increases above the lower limit capacity SC at time t5 though this charging operation, switching to the assistance mode is permitted. Thereafter, at time t6, the driving mode of the vehicle is switched to the assistance mode.

In the present embodiment, the prediction unit 26 predicts time t6, which is the start timing when the driving mode of the vehicle is switched to the assistance mode, and the capacity threshold SD is set so that switching to the assistance mode is permitted prior to this time t6. As a result, after activation of the power supply system 100, the switching to the assistance mode is not delayed due to a need to charge the rechargeable battery 16, and driving of the vehicle in the assistance mode may be started at the desired timing.

Thereafter, when the SOC of the rechargeable battery 16 increases to the first upper limit SA at time t7, the power switch SWB is opened by the first charging unit 25A and charging of the rechargeable battery 16 is thereby ceased.

Under the operational state of the power supply system, it is determined whether an abnormality has occurred in any of the first system ES1 and the second system ES2. In FIG. 3, a ground fault occurs in the first load 31 at time t8. As a result, when a power source failure occurs in the first system ES1, the inter-system switch SWA is opened and the power switch SWB is closed by the switch operating unit 24 at time t9. This allows the rechargeable battery 16 to provide a power supply backup for the loads 34 and 35 in the second ES2 system. Upon a power source failure occurring in the first system ES1, the ECU 36A is deactivated.

Subsequently, when a control unit other than the ECU 36A determines that a ground fault has occurred in the first load 31, the specific switch SWT is opened by the switch operating unit 24 at time t10. As a result, when the converter 12 is activated again, the loads 32 and 33 in the first system ES1 can operate and monitoring of the rechargeable battery 16 by the ECU 36A is resumed after the initial process for activation.

The present embodiment described in detail above can provide the following advantages.

In the present embodiment, the converter 12 is provided in the first system ES1 and the rechargeable battery 16 is provided in the second system ES2 to provide redundant power supplies from the converter 12 and the rechargeable battery 16 to the first to sixth loads 31 to 36. In this case, the rechargeable battery 16 is charged by the converter 12 with the inter-system switch SWA closed under the operational state of the power supply system. Therefore, even in the event that a power source failure occurs on the first system ES1 side, driving of the load 34 and 35 in the second system ES2 can be continued by the power from the rechargeable battery 16 on the second system ES2 side. In addition, under the non-operational state of the power supply system, dark current is supplied from the rechargeable battery 16 to the sixth load 36 with the inter-system switch SWA closed. In this case, the rechargeable battery 16 has a SOC higher than or equal to the lower limit capacity SC in preparation for occurrence of a power source failure on the first system ES1 side, and the dark current is appropriately supplied to the sixth load 36 while making effective use of the power in the rechargeable battery 16. This can properly achieve power supply redundancy and efficient use of the power of the converter 12 and the rechargeable battery 16 in the power supply system 100.

In the present embodiment, the capacity threshold SD at which charging is performed under the non-operational state of the power supply system is set to a smaller value than the lower limit capacity SC, which is the capacity that can provide a power supply backup for the loads 34, 35 in the second system ES2 under the operational state of the power supply system. In this case, the capacity range of the rechargeable battery 16 that can be used to supply dark current under the non-operational state of the power supply system is broadened, and dark current is supplied even when the SOC of the rechargeable battery 16 is lower than the lower limit capacity SC in the operational state of the power supply system. This can reduce the number of times the rechargeable battery 16 is charged under the non-operational state of the power supply system.

In particular, in the present embodiment, in the power supply system 100 applied to a vehicle capable of driving of the vehicle in the assistance mode, the capacity threshold SD at which the second charging unit 25B initiates charging under the non-operational state of the power supply system is set to a smaller value than the lower limit capacity SC, which is the capacity that can provide a power supply backup during driving of the vehicle in the assistance mode. This can reduce the number of times the rechargeable battery 16 is charged under the non-operational state of the power supply system while ensuring that a power supply backup is properly provided during driving of the vehicle in the assistance mode.

When the SOC of the rechargeable battery 16 falls below the lower limit capacity SC under the non-operational state of the power supply system, the SOC of the rechargeable battery 16 may be lower than the lower limit capacity SC at the time of system activation, and driving of the vehicle in the assistance mode may thus be delayed until the SOC of the rechargeable battery 16 is charged to the lower limit capacity SC or higher. In this regard, in the present embodiment, the start timing when the driving mode of the vehicle is switched to the assistance mode after transitioning from the non-operational state to the operational state of the power supply system is predicted, and the capacity threshold SD is set based on that start timing. This allows driving of the vehicle in the assistance mode to be started at the desired timing after the power supply system 100 is activated.

Under the operational state of the power supply system, the power supply backup for the load 34, 35 in the second system ES2 may be properly provided by keeping the SOC of the rechargeable battery 16 at a high capacity. However, there is concern that if the time period during which the SOC of the rechargeable battery 16 is kept at a high capacity is prolonged, the rechargeable battery 16 may likely deteriorate. In this regard, in the present embodiment, the second upper limit SB, which is the upper limit of rechargeable battery 16 under the non-operational state of the power supply system, is set to a smaller value than the first upper limit SA, which is the upper limit of rechargeable battery 16 under the operational state of the power supply system. In this case, the SOC of the rechargeable battery 16 is kept at a high capacity under the operational state of the power supply system, and the SOC of the rechargeable battery 16 is kept at a low capacity under the non-operational state of the power supply system. This can suppress deterioration of the rechargeable battery 16 while ensuring a power supply backup is provided properly under the operational state of the power supply system.

In the present embodiment, during dark current being supplied from the rechargeable battery 16 to the sixth load 36 under the non-operational state of the power supply system, the intra-system switches SWC other than the intra-system switch SWC corresponding to the sixth load 36 are opened, thereby preventing dark current from being supplied to the first to fifth loads 31 to 35 that do not need to be supplied with dark current. This can suppress the amount of dark current supplied from the rechargeable battery 16 under the non-operational state of the power supply system, and reduce the number of times the rechargeable battery 16 is charged under the non-operational state of the power supply system.

### First Modification to First Embodiment

The intra-system switch SWC corresponding to the sixth load 36 may be provided for each of the loads 36A and 36B included in the sixth load 36. In this case, under the non-operational state of the power supply system, when the SOC of the rechargeable battery 16 approaches the capacity threshold SD, the second charging unit 25B only opens the SWC corresponding to the remote-control key device 36B, among the intra-system switch SWC corresponding to the ECU 36A and the intra-system switch SWC corresponding to the remote-control key device 36B. This can more efficiently suppress the amount of dark current supplied from the rechargeable battery 16 under the non-operational state of the power supply system, thereby reducing the number of times the rechargeable battery 16 is charged under the non-operational state of the power supply system.

### Second Modification to First Embodiment

The second charging unit 25B may set the capacity threshold SD based on a rate of change (slope) of the SOC of the rechargeable battery 16 under the non-operational state of the power supply system, instead of or together with the start timing predicted by the prediction unit 26. For example, when an air conditioner or an audio device included in the first load 31 is used under the non-operational state of the power supply system, drive current is supplied to the first load 31 along with dark current to the sixth load 36. In this case, the rate of change of the SOC of the rechargeable battery 16 when the first load 31 is used is greater than the rate of change of the SOC of the rechargeable battery 16 when the first load 31 is not used, and there is concern that the number of times the rechargeable battery 16 is charged under the non-operational state may increase.

In this modification, the capacity threshold SD is set based on the rate of change of the SOC of the rechargeable battery 16 associated with discharging of the rechargeable battery 16 under the non-operational state of the power supply system. For example, if the rate of change of the SOC of the rechargeable battery 16 under the non-operational state of the power supply system is relatively large, the capacity threshold SD may be set lower. This may suppress an increase in the number of times the rechargeable battery 16 is charged under the non-operational state of the power supply system.

### Second Embodiment

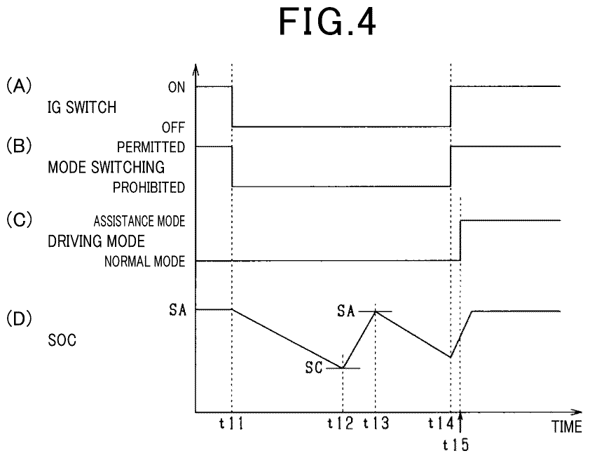

A second embodiment is similar in basic configuration to the first embodiment. Thus, duplicate description regarding the common configuration will be omitted and differences from the first embodiment will be mainly described below with reference to FIG. 4.

In the present embodiment, under the non-operational state of the power supply system, the second charging unit 25B differs from that of the first embodiment in that the second charging unit 25B charges the rechargeable battery 16 when the SOC of the rechargeable battery 16 drops to the lower limit capacity SC. In the present embodiment, under the non-operational state of the power supply system, the second charging unit 25B ceases charging the rechargeable battery 16 when the SOC of the rechargeable battery 16 increases to the first upper limit SA.

FIG. 4 illustrates the progress of the SOC of the rechargeable battery 16 under the non-operational state of the power supply system. In FIG. 4, the diagram (A) illustrates the progress of the on/off state of the IG switch 45, the diagram (B) illustrates the progress of the permission or prohibition of switching to the assistance mode, the diagram (C) illustrates the progress of the driving mode, and the diagram (D) illustrates the progress of the SOC of the rechargeable battery 16.

In the present embodiment, when the IG switch 45 is opened at time t11, the switch control unit 24 supplies dark current from the rechargeable battery 16 during the time period from time t11 to time t12, and when the SOC of the rechargeable battery 16 drops to the lower limit capacity SC at time t12, the rechargeable battery 16 is charged by the converter 12 based on controls by the second charging unit 25B. Then, when the SOC of the rechargeable battery 16 increases to the first upper limit SA at time t13, charging of the rechargeable battery 16 is ceased and dark current is supplied from the rechargeable battery 16 again.

At time t14, the IG switch 45 is closed. In the present embodiment, since the SOC of the rechargeable battery 16 is kept at a higher capacity than the lower limit capacity SC at the time of system activation, switching to the assistance mode is permitted at time t14 when the IG switch 45 is closed. In the present embodiment, the driving mode of the vehicle is switched to the assistance mode at time t15 immediately after time t14.

According to the present embodiment described in detail above, under the non-operational state of the power supply system, the rechargeable battery 16 is charged when the SOC of the rechargeable battery 16 drops to the lower limit capacity SC, which is the capacity that can provide a power supply backup while the vehicle is traveling in the assistance mode. In this case, since the SOC of the rechargeable battery 16 is kept at a higher capacity than the lower limit capacity SC under the non-operational state of the power supply system, a power supply backup for driving assistance can be provided by the rechargeable battery 16 even immediately after the power supply system 100 is activated. This allows driving of the vehicle in the assistance mode to be started as soon as possible immediately after system activation.

### Modification to the Second Embodiment

Under the non-operational state of the power supply system, the capacity at which the second charging unit 25B initiates charging of the rechargeable battery 16 may be switched between the lower limit capacity SC and the capacity threshold SD. For example, the capacity threshold SD may be selected when the driver delays the start timing of the assistance mode after system activation or when the driver has the intention of not driving of the vehicle in the assistance mode. In an example case of delaying the start timing of the assistance mode after system activation, for example, driving of the vehicle in the assistance mode after system activation is set, but the destination of the vehicle has not been set by the navigation device or other device.

The lower limit capacity SC and the capacity threshold SD may be switched based on the temperature of the rechargeable battery 16. The lower limit capacity SC is set to a relatively high capacity so that the rechargeable battery 16 can operate even when the temperature of the rechargeable battery 16 is lower than a predefined threshold temperature. Therefore, the capacity threshold SD may be selected when the temperature of the rechargeable battery 16 is higher than the threshold temperature, because the rechargeable battery 16 is likely to operate than when the temperature of the rechargeable battery 16 is lower than the threshold temperature.

The lower limit capacity SC and the capacity threshold SD may be switched based on the level of autonomous driving set by the driver. The lower limit capacity SC is set based on the highest level of autonomous driving among the levels of autonomous driving feasible for the vehicle. Therefore, if driving of the vehicle in the assistance mode after system activation is set, but the level of autonomous driving set by the driver is lower than the highest level of autonomous driving, the capacity threshold SD may be selected. Alternatively, if driving of the vehicle in the assistance mode after system activation is set, but the level of autonomous driving set by the driver is not feasible on the roads around the vehicle and driving of the vehicle in the assistance mode is not allowed, the capacity threshold SD may be selected.

### Other Embodiments

The disclosure is not limited to the above-described embodiments, and, for example, may be implemented as follows.

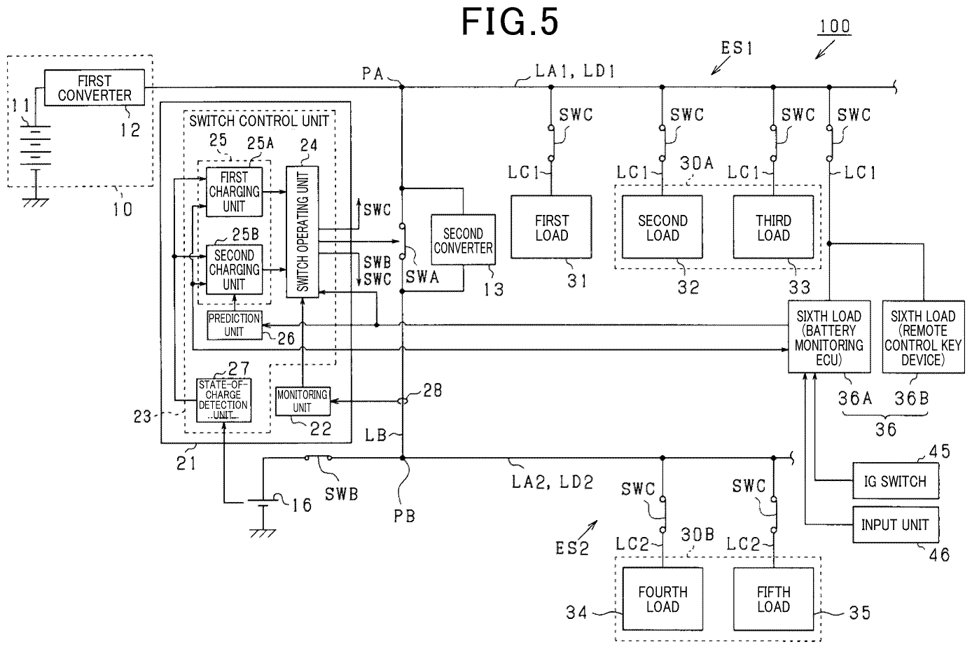

The second to fifth loads 32-35 may be, for example, the following devices.
(I) The second to fifth loads 32-35 may include motors for moving the vehicle and drive circuits thereof. In this case, each of the third and fifth loads 33 and 35 may include, for example, a three-phase permanent magnet synchronous motor and a three-phase inverter device, while each of the second and fourth loads 32 and 34 may include a control device for the three-phase inverter device.
(II) The second to fifth loads 32-35 may include anti-lock brake devices that prevent the wheels from locking during braking. In this case, each of the third and fifth loads 33 and 35 may include an ABS actuator that may, for example, independently adjust the brake hydraulic pressure during braking, and each of the second and fourth loads 32 and 34 may include a control device for the ABS actuator.
(III) The third load 33 and fifth load 35 do not necessarily have to be a combination of the same configuration, but may be a combination of equivalent functions realized by different types of devices. The third load 33 and fifth load 35 may not be different loads, but may be the same load. That is, the third load 33 and the fifth load 35 may be the same load that is supplied with electric power from both the first intra-system path LA1 and the second intra-system path LA2.
(IV) Under the non-operational state of the power supply system, the second charging unit 25B may charge the rechargeable battery 16 when the SOC of the rechargeable battery 16 drops to the capacity threshold SD and may cease charging the rechargeable battery 16 when the SOC of the rechargeable battery 16 increases to the first upper limit SA. The second charging unit 25B may charge the rechargeable battery 16 when the SOC of the rechargeable battery 16 drops to the capacity threshold SD, and may cease charging the rechargeable battery 16 when the SOC of the rechargeable battery 16 increases to the second upper limit SB, which is set to a larger value than the first upper limit SA. This allows the capacity range of the rechargeable battery 16 that can be used to supply dark current to be broadened, thereby reducing the number of times the rechargeable battery 16 is charged under the non-operational state of the power supply system.
(V) In the above embodiments, an example has been described where the rechargeable battery 16 provides a power supply backup in the assistance mode. Alternatively, the rechargeable battery 16 may provide a power supply backup in the normal mode.
(VI) In the above embodiments, an example has been described where the rechargeable battery 16 is charged to a voltage equal to the operating voltage of the converter 12. Alternatively, for example, the rechargeable battery 16 may be charged to a voltage higher than the operating voltage of the converter 12. In this case, as illustrated in FIG. 5, a DC-DC converter (simply called a converter) 13 may be provided in parallel with the inter-system switch SWA. In the following, the converter 12 is referred to as a first converter and the converter 13 is referred to as a second converter.

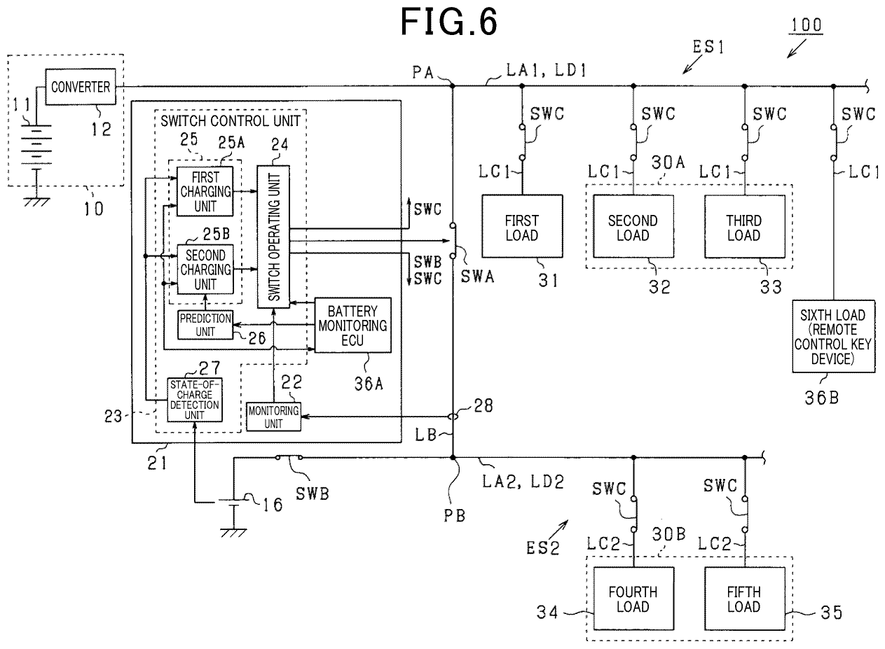

The first charging unit 25A and the second charging unit 25B open the inter-system switch SWA and put the second converter 13 in the operational state when the rechargeable battery 16 is to be charged. When keeping the rechargeable battery 16 charged, the first charging unit 25A opens the inter-system switch SWA and puts the second converter 13 in the non-operational state. The second charging unit 25B closes the inter-system switch SWA and places the second converter 13 in the operational state when supplying dark current from the rechargeable battery 16.
(VII) In the above embodiments, an example has been described where the ECU 36A is provided separately from the switch control unit 21. As illustrated in FIG. 6, the ECU 36A may be provided in the switch control unit 21. This allows the high-voltage rechargeable battery 11 and the converter 12 to be activated or deactivated by the switch control unit 21 itself.
(VIII) In the above embodiments, an example has been described where each of the monitoring unit and the switch control unit is configured as hardened circuitry with various types of control circuits built in. Alternatively, each of the monitoring unit and the switch control unit may be configured as a microcomputer including a CPU, ROM, RAM, flash memory, or the like.
(IX) In the above embodiments, an example has been described where the power storage device is a rechargeable lithium-ion battery. Alternatively, the power storage device may be any other type of rechargeable battery, for example, it may be an electric double layer capacitor.

Although the present disclosure has been described in accordance with the above-described embodiments, it is not limited to such embodiments, but also encompasses various variations and variations within equal scope. In addition, various combinations and forms, as well as other combinations and forms, including only one element, more or less, thereof, are also within the scope and idea of the present disclosure.

What is claimed is:

1. A power source monitoring device for a power supply system equipped with a first system including a first power source and a second system including a second power source, the first and second systems being connectable to each other by an inter-system switch, the inter-system switch being configured to be closed under an operational state of the power supply system to supply power to electrical loads connected to a respective one of the first and second systems, the first power source including a voltage generation unit configured to generate an operating voltage for the electrical loads, the second power source including a power storage device chargeable by the voltage generation unit, the power source monitoring device comprising:
a charging control unit configured to, under the operational state of the power supply system, close the inter-system switch and cause the voltage generation unit to charge the power storage device; and
a dark current supply unit configured to, under a non-operational state of the power supply system, close the inter-system switch and supply dark current from the power storage device to the electrical loads.

2. The power source monitoring device according to claim 1, wherein the charging control unit comprises:
a first charging unit configured to cause the power storage device to be charged so that, under the operational state of the power supply system, a remaining capacity of the power storage device is higher than or equal to a lower limit capacity which is a capacity to allowed provide a power supply backup for the electrical loads; and
a second charging unit configured to cause the power storage device to be charged under a non-operational state of the power supply system when the remaining capacity of the power storage device is lower than the lower limit capacity and falls to a capacity threshold which is a capacity allowed to supply dark current to the electrical loads.

3. The power source monitoring device according to claim 2, wherein
the power supply system is an on-board power supply system for a vehicle, the electrical loads are loads for implementing driving assistance functions in the vehicle; and
the first charging unit is configured to cause the power storage device to be charged under the operational state of the power supply system so that the remaining capacity of the power storage device is higher than or equal to a lower limit capacity that is a capacity allowed to provide a power supply backup while driving assistance is being performed, and
the second charging unit is configured to cause the power storage device to be charged under the non-operational state of the power supply system so that the remaining capacity of the storage device has dropped to a capacity threshold that is a capacity lower than the lower limit capacity.

4. The power source monitoring device according to claim 3, further comprising:
a prediction unit configured to predict a start timing when the driving assistance is started after transitioning from the non-operational state to the operational state of the power supply system, wherein
the second charging unit is configured to set the capacity threshold based on the start timing.

5. The power source monitoring device according to claim 2, wherein
the second charging unit is configured to set the capacity threshold based on a rate of change of the remaining capacity of the power storage device associated with discharging of the power storage device under the non-operational state of the power supply system.

6. The power source monitoring device according to claim 2, wherein
the first charging unit is configured to cause the power storage device to be charged under the operational state of the power supply system with an upper limit of the remaining capacity of the power storage device set as a first upper limit, and
the second charging unit is configured to cause the power storage device to be charged under the non-operational state of the power supply system with the upper limit of the remaining capacity of the power storage device set as a second upper limit, which is lower than the first upper limit.

7. The power source monitoring device according to claim 1, wherein
the power supply system is an on-board power supply system for a vehicle,
the electrical loads are loads for implementing driving assistance functions in the vehicle; and
the charging control unit comprises:
a first charging unit configured to cause the power storage device to be charged so that, under the operational state of the power supply system, a remaining capacity of the power storage device is higher than or equal to a lower limit capacity which is a capacity allowed to provide a power supply backup for the electrical loads while the vehicle is driven in a driving assistance mode; and
a second charging unit configured to cause the power storage device to be charged under a non-operational state of the power supply system when the remaining capacity of the power storage device falls to the lower limit capacity.

8. The power source monitoring device according to claim 1, wherein
the electrical loads include a load that does not need to be supplied with dark current under the non-operational state of the power supply system and a load that needs to be supplied with dark current under the non-operational state of the power supply system,
the first and second systems include an intra-system switch provided in an energization path leading to the load that does not need to be supplied with dark current under the non-operational state of the power supply system, and the dark current supply unit is configured to, under the non-operational state of the power supply system, open the intra-system switch and close the inter-system switch to cause the power storage device to supply dark current to the load that needs to be supplied with dark current under the non-operational state of the power supply system.
